(19) United States
(12) Patent Application Publication
(10) Pub. No.: US 2012/0154211 A1
(43) Pub. Date: Jun. 21, 2012

(54) ELECTRONIC DEVICE FOR TRACKING AND MONITORING OF TOPOGRAPHY EQUIPMENT

(76) Inventor: Saturnino BERAJAS ENDEZ, Mosquera (CO)

(21) Appl. No.: 13/172,337

(22) Filed: Jun. 29, 2011

(30) Foreign Application Priority Data
Dec. 16, 2010 (CO) 10-157978

(51) Int. Cl. G01S 19/42; G01S 19/16; G01S 5/02

(52) U.S. Cl. 342/357.25; 342/451; 342/357.54

(57) ABSTRACT

An electronic device having a system for tracking and monitoring to recover and/or service topography equipment. The electronic device is hidden within the topography equipment by a certified technician and is registered in an operating center. When desired by the operating center, a SIM card connects through a cell phone carrier to enable monitoring and geographic localization of the topography equipment by the operating center, whereby a GPS antenna receives the signal from a satellite via a modem. Therefore, the owner, authorized personnel and/or police officer(s) can then track the signal and locate the topography equipment for recovery and/or service maintenance.

### BACKGROUND OF THE INVENTION

1. Field of the Invention

The present invention relates to electronic devices, and more particularly, to an electronic device and system for tracking and monitoring topography equipment.

2. Other Related Applications

The present application is claiming priority of Colombia Application No. 10-157978 filed on Dec. 16, 2010, which is hereby incorporated by reference.

3. Description of the Related Art

Topography equipment is expensive, and unfortunately often stolen. Applicant is not aware of any electronic devices having systems for tracking and monitoring topography equipment having the innovative features of the present invention.

### SUMMARY OF THE INVENTION

The instant invention is an electronic device having a system for tracking and monitoring to recover or service topography equipment. The electronic device is hidden within the topography equipment by a certified technician and is registered in an operating center. When desired by the operating center, a SIM card connects through a cell phone carrier to enable monitoring and geographic localization of the topography equipment by the operating center when a GPS antenna receives the signal from a satellite via a modem. Therefore, the owner, authorized personnel and/or police officer(s) can then track the signal and locate the topography equipment for recovery and/or service maintenance.

It is therefore one of the main objects of the present invention to provide an electronic device for tracking and monitoring topography equipment to track a signal and locate the topography equipment for recovery and/or service through satellite signals.

It is another object of this invention to provide an electronic device for tracking and monitoring topography equipment that does not affect its functionality or precision.

It is another object of this invention to provide an electronic device for tracking and monitoring topography equipment that allows receiving of GPS signals or information through a tracking chip's Modem via a cell phone carrier to a server located in a raking and monitoring station to detect its location in the world.

It is another object of this invention to provide an electronic device for tracking and monitoring topography equipment that is volumetrically efficient for carrying, transporting, and storage.

It is another object of this invention to provide an electronic device for tracking and monitoring topography equipment that can be readily assembled and disassembled without the need of any special tools.

It is another object of this invention to provide an electronic device for tracking and monitoring topography equipment, which is of a durable and reliable construction.

It is another object of this invention to provide an electronic device for tracking and monitoring topography equipment, which utilizes the topography equipment's battery as a primary battery.

It is yet another object of this invention to provide such a device that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents an isometric view of the instant invention being mounted within topography equipment.

FIG. 2 is a front view of the instant invention.

FIG. 2A is a front view of internal components of the instant invention.

FIG. 3 is a rear view of the instant invention.

FIG. 3A is a rear view of the internal components of the instant invention.

FIG. 4 represents an electronic circuit of the internal processor of the instant invention.

FIG. 5 represents an electronic circuit of the internal modem of the instant invention.

FIG. 6 represents an electronic circuit of the antenna of the instant invention.

### DETAILED DESCRIPTION OF THE PREFERRED EMBODIMENT

Referring now to the drawings, the present invention is defined as an electronic device for tracking and monitoring of topography equipment and is generally referred to as tracking chip 10.

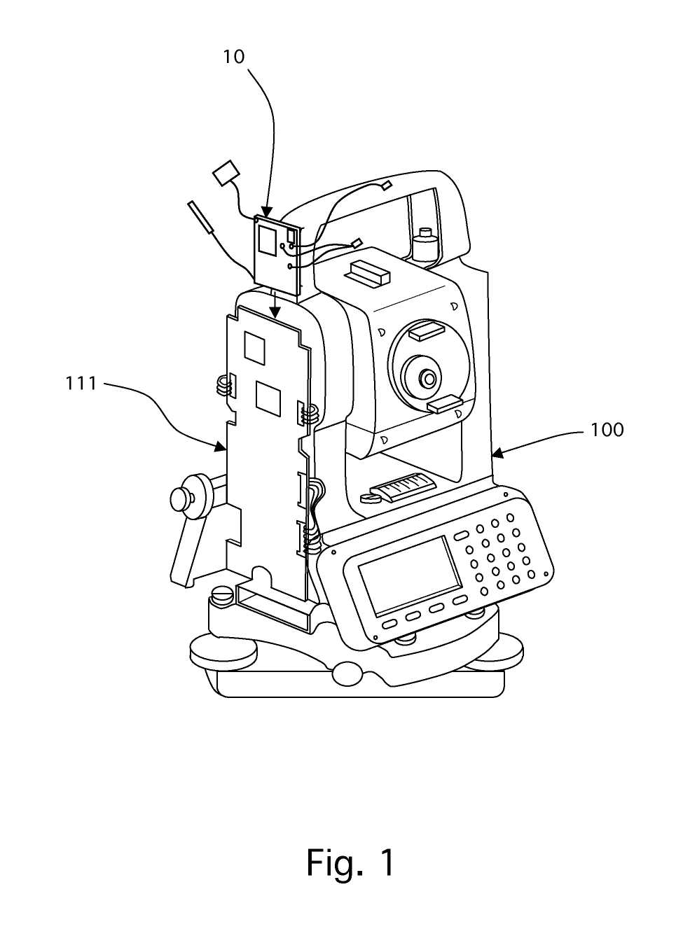

As seen in FIG. 1, for illustrative purposes, tracking chip 10 is illustrated externally of topography equipment 100. However, it is understood that while operational, tracking chip 10 is mounted and secured within topography equipment 100. Topography equipment 100 is defined as a total station.

A total station is an electronic/optical instrument used in modern surveying, and more specifically, the total station is an electronic theodolite (transit) integrated with an electronic distance meter (EDM) to read slope distances from the instrument to a particular point. In the preferred embodiment, the reading out of horizontal and vertical circles by topography equipment 100 is done electronically. The readout is done by a rotary encoder, which can be absolute, e.g. using Gray codes, or incremental, using equidistant light and dark radial bands. In the latter case the circles spin rapidly, reducing angle measurement to electronic measurement of time differences. Additionally, charge-coupled device (CCD) sensors are added to a focal plane of a telescope allowing both auto-targeting and the automated measurement of residual target offset. All this is implemented in embedded software of topography equipment 100.

Topography equipment 100 is further equipped with integrated electro-optical distance measuring devices, generally infrared based, including lasers, allowing the measurement in one go of complete three-dimensional vectors—albeit in instrument—defined polar co-ordinates, which can then be transformed to a pre-existing co-ordinate system in the area by means of a sufficient number of control points. This technique is called a resection solution or free station position surveying.

Topography equipment 100 also comprises central processing unit (CPU) 111. CPU 111 carries out the instructions of the embedded software, and is the primary element carrying out the functions of a processing device within topography equipment 100. CPU 111 carries out each instruction of a program in sequence, to perform basic arithmetical, logical, and input/output operations. Therefore, saving data into internal registering units, or into external data storage devices. Typically, ruggedized laptops or PDAs are used as data collectors for this purpose.

In the preferred embodiment, tracking chip 10 is connected to CPU 111 and also a power source, such as a battery that serves as a primary battery, within topography equipment 100. It is noted that tracking chip 10 does not interfere or disrupt the functionality of topography equipment 100. Cellular antenna 20 has operating specifications that do not interfere or disrupt the functionality of topography equipment 100 either. While connected to the battery within topography equipment 100, it supplies electrical current to tracking chip 10. The electrical current may be of 6 or 12 volts as an example. In addition, topography equipment 100 comprises at least one serial number 112 placed thereon by means of a laser, making it difficult for anyone to alter or modify them. In a preferred embodiment, the at least one serial number 112 is of very small dimensions, whereby magnification beyond standard human 20/20 vision is required to properly determine each number, symbol, character, or element of the at least one serial number 112.

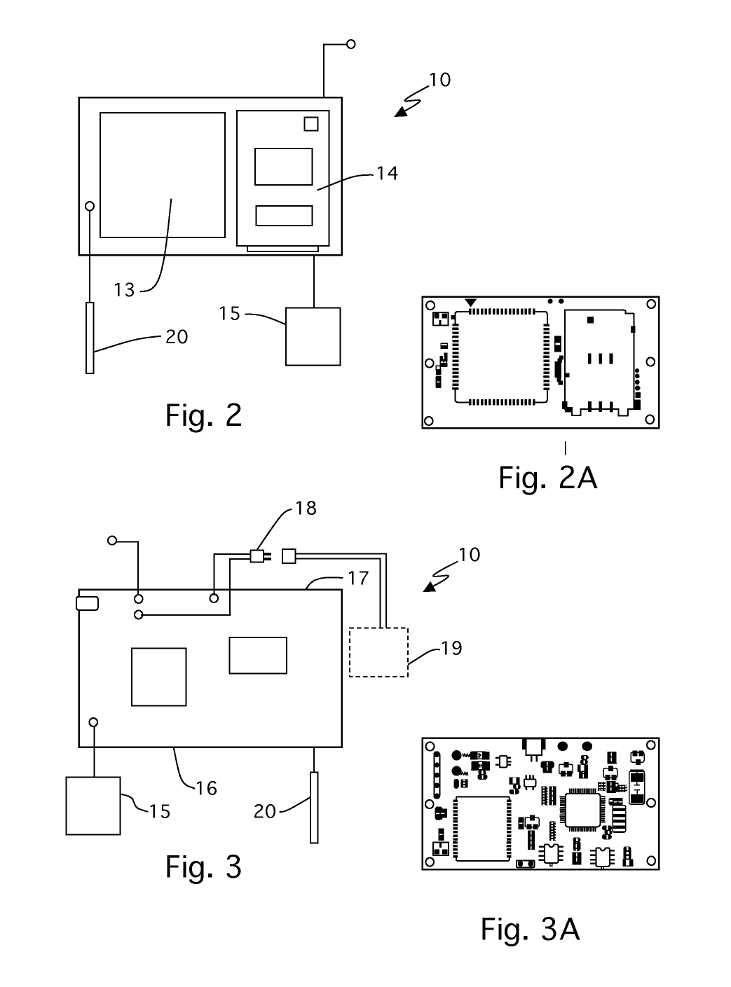

As seen in FIGS. 2 and 2A, tracking chip 10 comprises modem 13, a cellular-type subscriber identity module or subscriber identification module (SIM), SIM card 14, global positioning system (GPS), GPS antenna 15, and cellular antenna 20. When activated, tracking chip 10 receives a signal to enable monitoring and geographic localization of topography equipment 100 by an operating center.

As seen in FIGS. 3 and 3A, tracking chip 10 also comprises processor or CPU 17, and GPS signal processor 16. In addition, connectors 18 connect security battery 19 to the battery within topography equipment 100 via electronic circuitry. SIM card 14 connects through a cell phone carrier to enable monitoring and geographic localization of topography equipment 100 by the operating center, whereby GPS antenna 15 receives the signal from a satellite via modem 13 when activated by the operating center.

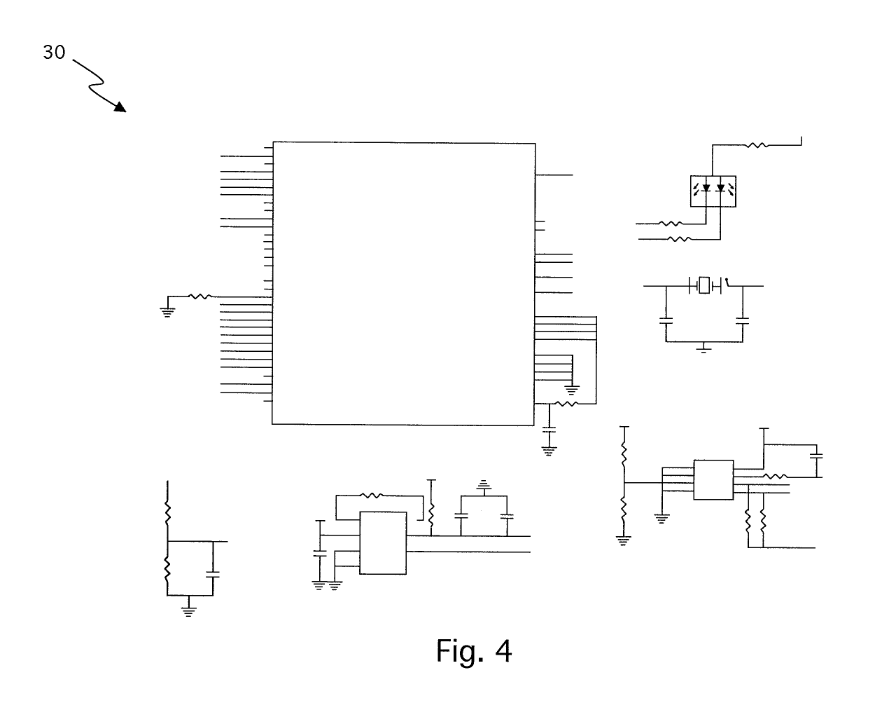

Seen in FIG. 4 is an example electronic circuit 30 of CPU 17.

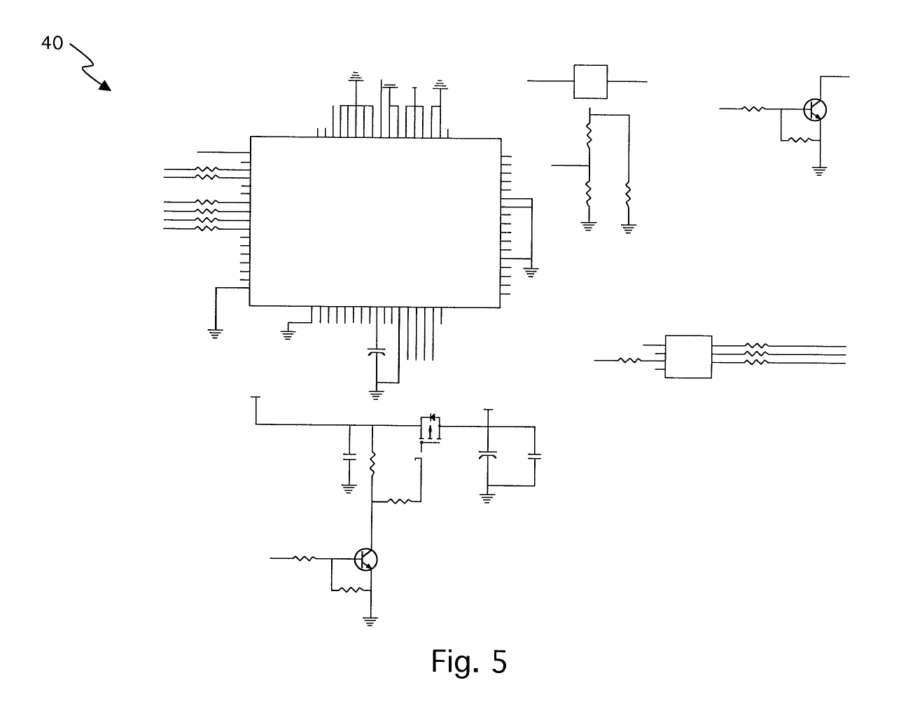

Seen in FIG. 5 is an example electronic circuit 40 of modem 13.

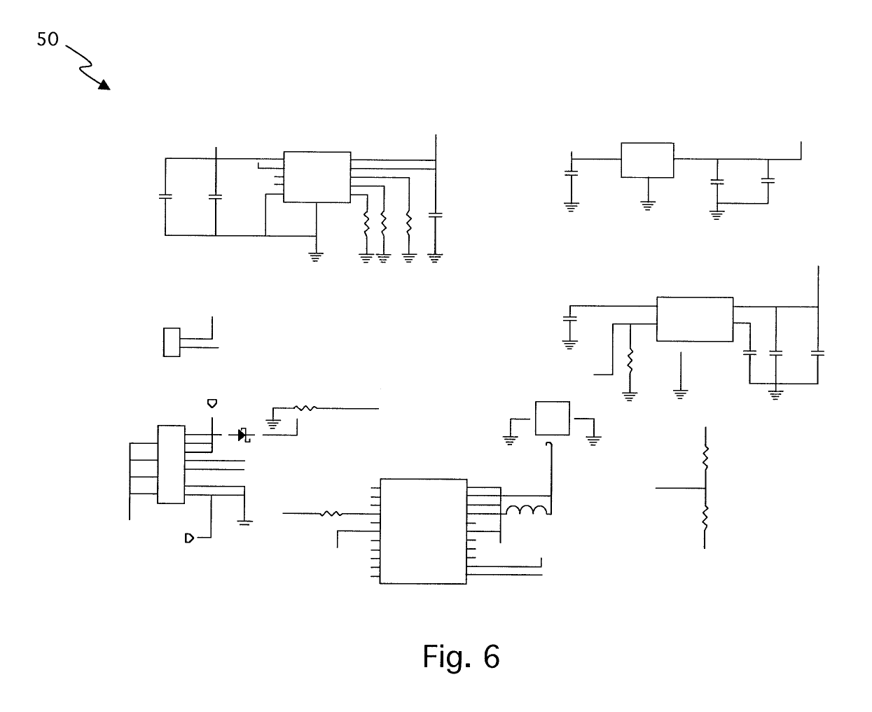

Seen in FIG. 6 is an example electronic circuit 50 of GPS antenna 15.

In operation, tracking chip 10 is a system for tracking and monitoring to recover and/or service topography equipment 100. Tracking chip 10 is hidden within topography equipment 100 by a certified technician and is registered in the operating center. When desired by the operating center, SIM card 14 connects through the cell phone carrier to enable monitoring and geographic localization of topography equipment 100 by the operating center, whereby GPS antenna 15 receives the signal from the satellite via modem 13. Therefore, the owner, authorized personnel and/or police officers can then track the signal and locate topography equipment 100 having tracking chip 10 therein for recovery and/or service maintenance.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. An electronic device and system for tracking and monitoring surveying equipment comprising:
A) a tracking chip having a modem, a subscriber identification module card, a global positioning system antenna, a cellular antenna, a processor or first CPU, a GPS signal processor, and a security battery; and
B) topography equipment comprising a second CPU and a power source, said tracking chip is connected to said second CPU and said power source.

2. The electronic device and system for tracking and monitoring surveying equipment set forth in claim 1, further characterized in that said security battery is connected to said power source within said topography equipment via electronic circuitry.

3. The electronic device and system for tracking and monitoring surveying equipment set forth in claim 1, further characterized in that said power source is a primary battery.

4. The electronic device and system for tracking and monitoring surveying equipment set forth in claim 1, further characterized in that said tracking chip does not interfere or disrupt functionality of said topography equipment.

5. The electronic device and system for tracking and monitoring surveying equipment set forth in claim 1, further characterized in that said power source supplies electrical current to said tracking chip.

6. The electronic device and system for tracking and monitoring surveying equipment set forth in claim 1, further characterized in that said topography equipment comprises at least one serial number placed thereon by means of a laser.

7. The electronic device and system for tracking and monitoring surveying equipment set forth in claim 6, further characterized in that to be visible, said at least one serial number requires magnification beyond standard human 20/20 vision to properly determine each number, symbol, character, or element of said at least one serial number.

8. The electronic device and system for tracking and monitoring surveying equipment set forth in claim 1, further characterized in that said SIM card connects through a cell phone carrier to enable monitoring and geographic localization of said topography equipment by an operating center, whereby said GPS antenna receives a signal from a satellite via said modem when activated by said operating center.

9. An electronic device and system for tracking and monitoring surveying equipment comprising:
A) a tracking chip having a modem, a subscriber identification module card, a global positioning system antenna, a cellular antenna, a processor or first CPU, a GPS signal processor, and a security battery; and
B) topography equipment comprising a second CPU and a power source, said tracking chip is connected to said second CPU and said power source, said security battery is connected to said power source within said topography equipment via electronic circuitry.

10. The electronic device and system for tracking and monitoring surveying equipment set forth in claim 9, further characterized in that said power source is a primary battery.

11. The electronic device and system for tracking and monitoring surveying equipment set forth in claim 10, further characterized in that said tracking chip does not interfere or disrupt functionality of said topography equipment.

12. The electronic device and system for tracking and monitoring surveying equipment set forth in claim 11, further characterized in that said power source supplies electrical current to said tracking chip.

13. The electronic device and system for tracking and monitoring surveying equipment set forth in claim 12, further characterized in that said topography equipment comprises at least one serial number placed thereon by means of a laser.

14. The electronic device and system for tracking and monitoring surveying equipment set forth in claim 13, further characterized in that to be visible, said at least one serial number requires magnification beyond standard human 20/20 vision to properly determine each number, symbol, character, or element of said at least one serial number.

15. The electronic device and system for tracking and monitoring surveying equipment set forth in claim 14, further characterized in that said SIM card connects through a cell phone carrier to enable monitoring and geographic localization of said topography equipment by an operating center, whereby said GPS antenna receives a signal from a satellite via said modem when activated by said operating center.
